(19) United States
(12) Patent Application Publication
(10) Pub. No.: US 2005/0147398 A1
(43) Pub. Date: Jul. 7, 2005

(54) Digital video recorder disc labeling

(76) Inventors: Daryl E. Anderson, Corvallis, OR (US); Andrew L. Van Brocklin, Corvallis, OR (US); Timothy F. Myers, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/752,078

(22) Filed: Jan. 6, 2004

(51) Int. Cl. H04N 5/781

(52) U.S. Cl. 386/125; 386/126

(57) ABSTRACT

A digital video recorder is configured with an interface to receive broadcast content. A user input device allows specifying label data related to the broadcast content. An optical disc drive of the digital video recorder writes the broadcast content to an optical disc and electro-optically labels the optical disc with the specified label data.

### BACKGROUND

Digital video recorders are devices that are able to record and play back audio/video (A/V) content that includes broadcast television shows, concerts, movies, and events. Digital video recorders may make use of a hard drive to record such A/V content; however, an alternative recording medium is a writeable optical disc such as a digital versatile disc (DVD). When writing to and playing back an optical disc, a digital video recorder may make use of various current and evolving recording standards and formats such as DVD+RW, DVD-R, DVD−RW.

Writing to an optical disc allows the optical disc to be physically exchanged with other play back devices and other users. A user may create a physical library of optical discs containing volumes of television shows, concerts, movies, and events. One optical disc may be used to store a particular movie, a particular episode of a show, or a particular event. Unless the user creates a physical mark on the optical discs, the user may be unable to distinguish one optical disc from another. Furthermore, the user may not know what is stored on a particular optical disc such as when a show was broadcasted, the episode of the particular show, and actors in the show. As the user's library of optical discs grows, the problem of identifying optical discs also grows.

The user may manually write on a non-data side of an optical disc; however, the quality and amount of information that is physically written on the optical disc depends on the skill and patience of the user. Writing on many optical discs can become a long and tedious task. Labels may be created and pasted on the non-data side of the optical disc, but this typically requires a separate process of creating a label on a different machine (e.g., a computer and a printer, or a standalone disc labeling unit), and sometimes physically pasting the label on the optical disc. In addition, the user may be required to gather and enter the information to be added to the label. This process may include having to enter or handwrite broadcast date, episode number, graphics, and any other desired label information.

For these and other reasons, there is a need for the present invention.

### SUMMARY

A digital video recorder is configured with an interface to receive broadcast content. A user input device allows specifying label data related to the broadcast content. An optical disc drive of the digital video recorder writes the broadcast content to an optical disc and electro-optically labels the optical disc with the specified label data.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is a block diagram illustrating one embodiment according to the present invention of a system to send and receive broadcasts to be recorded on an optical disc, along with graphics and text to be printed on the optical disc.

FIG. 2 is a block diagram illustrating one embodiment according to the present invention of an optical disc drive recorder and user interface to record, play, and mark a label on an optical disc medium, and usable with the system of FIG. 1.

FIG. 3 is a block diagram illustrating one embodiment according to the present invention of an optical disc drive system used to mark a label on an optical disc, and usable with the recorder of FIG. 2.

FIG. 4 is a flow chart illustrating one embodiment according to the present invention of a process for adding text and/graphics to an optical disc label.

### DETAILED DESCRIPTION

The following discussion is directed to systems and methods for a device such as a digital video recorder to label an optical disc (e.g., a DVD) with text and/or graphics that a user authors or obtains from a source. The same device (i.e., digital video recorder) records content and performs the labeling.

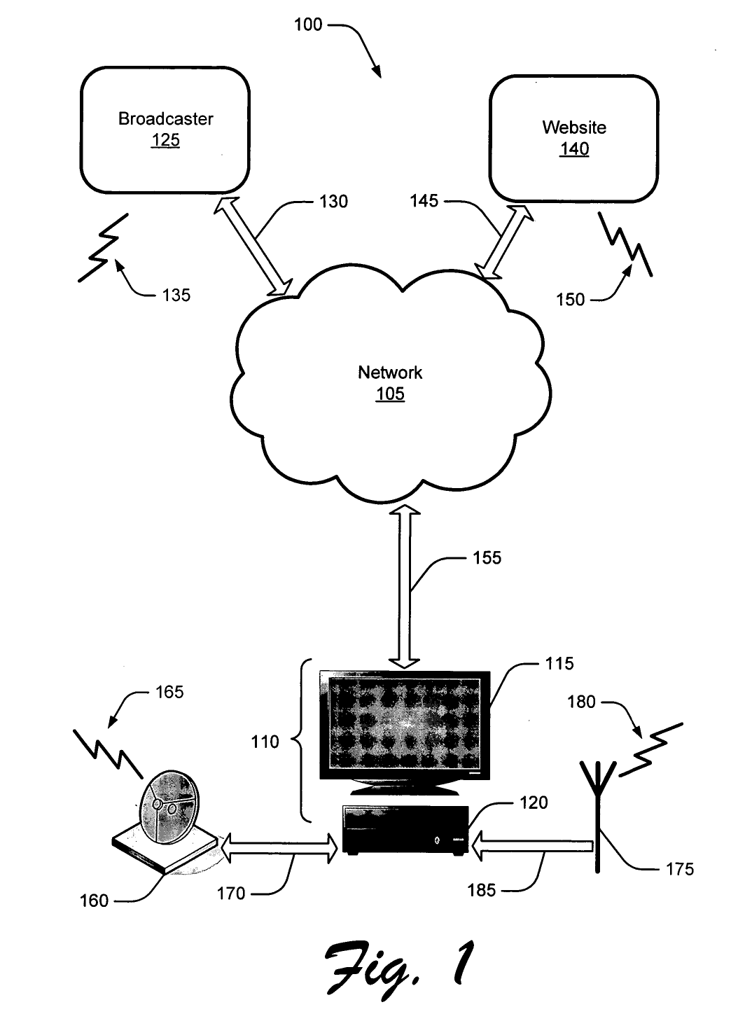

FIG. 1 shows an exemplary system 100 for sending and receiving text and/or graphics to be printed on optical disc media. System 100 includes a network 105 which comprises one or more networks such as the Internet, intranets, telephone networks, and cable television networks. Network 100 is capable of carrying various types of information and data that includes audio, video, analog, digital, text, and graphics.

Connected to network 100 is a digital video recorder system 110. Digital video recorder system 110 includes a display 115 and a digital video recorder 120. Digital video recorder system 110 is configured to receive audio/video content from a source such as a broadcaster 125.

Broadcaster 125 may be one of several content sources such as a television station, a cable television provider, a closed-circuit broadcaster, or an Internet site. Broadcaster 125 is connected to and transmits/receives content to network 105 through an interface 130. Interface 130 is a two-way interface between broadcaster 125 and network 105. Therefore, broadcaster 125 is able to transmit and receive content and data. Alternatively, broadcaster 125 may transmit radio frequency (RF) signals 135. In this embodiment, content is sent as RF transmission directly to a party (e.g. digital video recorder system 110) or through an intermediary such as a satellite station.

In certain cases, content is broadcast as separate streams. In other words there may be separate streams for video content and audio content. In certain cases, audio and video content may be interleaved with one another. In particular instances, programming information indicative of the content may be interleaved or combined with a video stream. For example, programming information may be included in an electronic program guide or EPG. The EPG may be interleaved or laid over a broadcasted video stream. A device such as digital video recorder system 110 that receives the video content also receives the EPG. EPGs platforms such as “Guideplus” by Gemstar, Inc. provide users with programming information related to broadcasted contents. Programming information may include the day and time an event was broadcasted; an episode number of a particular show; and may also include graphics related to the broadcasted content. Such programming information may be used as optical disc label text and/or graphics (i.e., label data) for an optical disc used by video recorder system 110 to record the content.

Network 105 may also be connected to a website 140 through an interface 145. Interface 145 is a two-way interface between website 140 and network 105, therefore website 140 is able to transmit and receive content and data. Website 140 may contain and provide label data to video recorder system 110. For example website 140 may be a television programming guide website that provides detailed description of shows and programs. Digital video recorder system 110 is configured to communicate with website 140 through network 105 to seek out and download label data for use in creating a label to an optical disc in video recorder system 110. In certain cases, content may be received from a source such as broadcaster 125; however, broadcaster 125 may not provide the appropriate label data. Therefore video recorder system 110 communicates with website 140 to obtain the label data. Website 140 may also transmit. RF signals 150 that include label data to video recorder system 110.

In this example digital video recorder system 110 is connected to network-105 through a two-way interface 155, allowing digital video recorder system 110 to receive content and data, as well as request particular content and data such as label data from website 140.

Alternatively, digital video recorder system 110 may be connected to a satellite dish 160 which receives and transmits RF signals 165. In particular, RF signals 165 may include content from parties such as broadcaster 125. Satellite dish 160 may also receive content from and transmit content to website 140. A two-way interface 170 connects digital video recorder 110 with satellite dish 160. Digital video recorder system 110 may further be connected to an RF antenna 175 that receives RF signals 180. Typically, digital video recorder system 110 is only able to receive content through RF antenna 175, and not transmit content using antenna 175. Communication between digital video recorder system 110 and RF antenna is provided by a one-way interface 185.

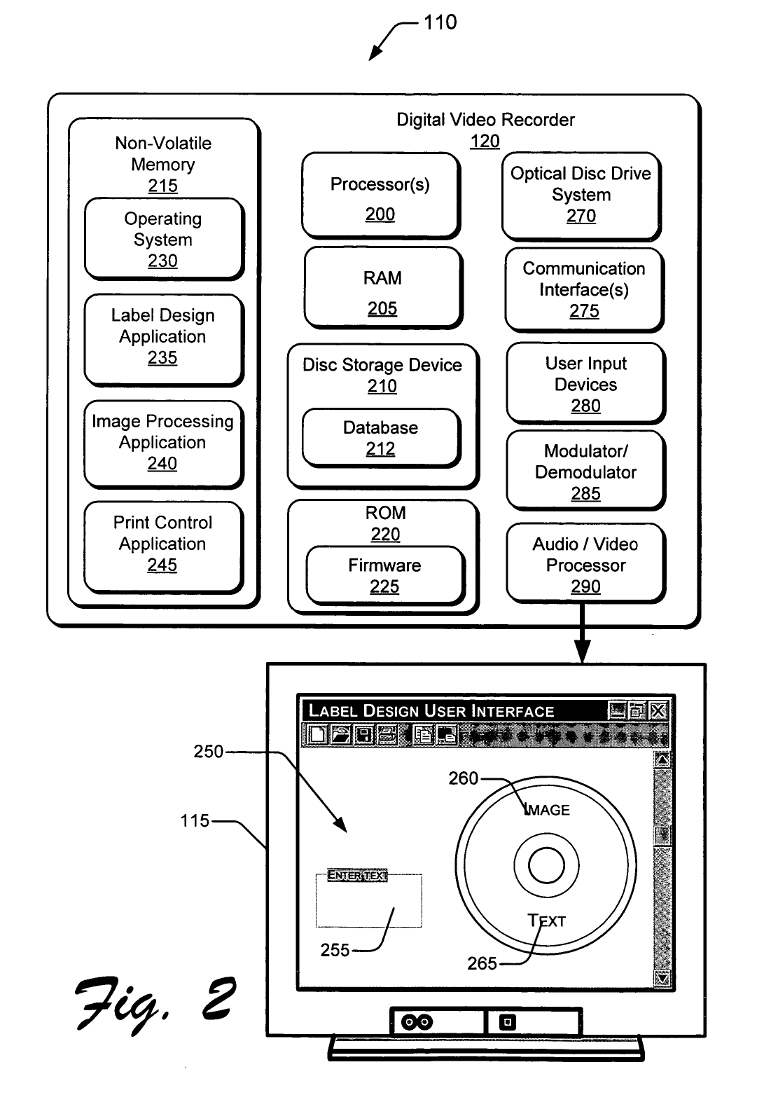

FIG. 2 shows one embodiment of digital video recorder system 110 shown in FIG. 1. Digital video recorder system 110 is particularly suitable for obtaining label data for use on an optical disc such as a DVD. The digital video recorder system 110 includes the digital video recorder 120 and display 115 shown in FIG. 1. The digital video recorder 120 may be implemented as a stand-alone appliance device for recording and labeling optical discs.

Digital video recorder 120 includes one or more processors 200 (e.g., microprocessors, controllers, and the like) which process various instructions to control the operation of digital video recorder 120 and communicate with other electronic and computing devices. Digital video recorder 120 may be implemented with one or more memory components, examples of which include a random access memory (RAM) 205, a disc storage device 210, and non-volatile memory 215 (e.g., any one or more of a read-only memory (ROM) 220, flash memory, EPROM, EEPROM, etc.).

Disc storage device 210 may include any type of magnetic or optical storage device, such as a hard disc drive, a magnetic tape, a recordable and/or rewriteable compact disc (CD), a DVD, DVD+RW, and the like.

Disc storage device 210 includes a database 212 that may contain label data used in creating labels for optical discs. A user may select particular label data (e.g., text and/or graphics data) from database 212 to be used for a particular optical disc.

The one or more memory components provide data storage mechanisms to store various information and/or data such as configuration information for digital video recorder 120, graphical user interface information, and any other types of information and data related to operational aspects of digital video recorder 120. Alternative implementations of digital video recorder 120 may include a range of processing and memory capabilities, and may include any number of differing memory components from those shown in FIG. 2.

Digital video recorder 120 includes a firmware component 225 which is implemented as a permanent memory module stored on ROM 220, or with other components in digital video recorder 120, such as a component of a processor(s) 200. Firmware 225 is programmed and distributed with digital video recorder 120 to coordinate operations of the hardware within digital video recorder 120 and contains programming constructs used to perform such operations.

An operating system 230 and one or more application programs may be stored in non-volatile memory 215 and executed on processor(s) 200 to provide a runtime environment. A runtime environment facilitates extensibility of digital video recorder 120 by allowing various interfaces to be defined that, in turn, allow the application programs to interact with digital video recorder 120. In this example, the application programs include a label design application 235, an image processing application 240, and a print control application 245.

The label design application 235 generates a label design user interface 250 for display on the display 115 from which a user may create a label image to be rendered on a disc media, such as on an optical disc. The user may specify, or otherwise drag and drop text, a bitmap image for background, a digital photo, a graphic or symbol, and/or any combination thereof to create the label image on the label design user interface 250. As discussed above, optical disc label text and/or graphics may be received from a source such as broadcaster 125 or website 140 of FIG. 1, and is descriptive of content that is recorded on a particular optical disc. Alternatively the user may enter text in a text area 255. User interface 250 further provides a preview image of the label illustrating image 260 (i.e., graphics) and text 265 to be imprinted as a label on the optical disc.

The image processing application 240 processes the label image created with the label design user interface 250 to produce a data stream of label image data and laser control data to control rendering the image on concentric circular tracks of a disc media (i.e., an optical disc). For example, a continuous tone RGB (red, green, and blue) rectangular raster graphic of the label image 260 may be converted to concentric circular tracks. The curved raster is color mapped and separated into the printing color channels, for example KCMY (black, cyan, magenta, and yellow), or grayscale. This data stream is formatted as laser control data and is augmented with other control commands to control the digital video recorder 120 rendering a label on the disc media.

An optical disc label file may be generated and communicated to a controller, where the optical disc label file is processed and sent to a labeling mechanism. Alternatively, the concentric circular tracks may be generated by a host external to DVR 120 and streamed to the digital video recorder 120 one track at a time to utilize host processing with the device's rendering process.

The print control application 245 determines the radius of the first track and the subsequent track spacing. After the radius of the first track and the track spacing is determined, the print control application 245 determines which label image data will correspond to each respective track. The laser mark locations along a particular track are specified in a coordinate system where the concentric circular tracks are defined in coordinates of the radial distance and the distance along each respective track.

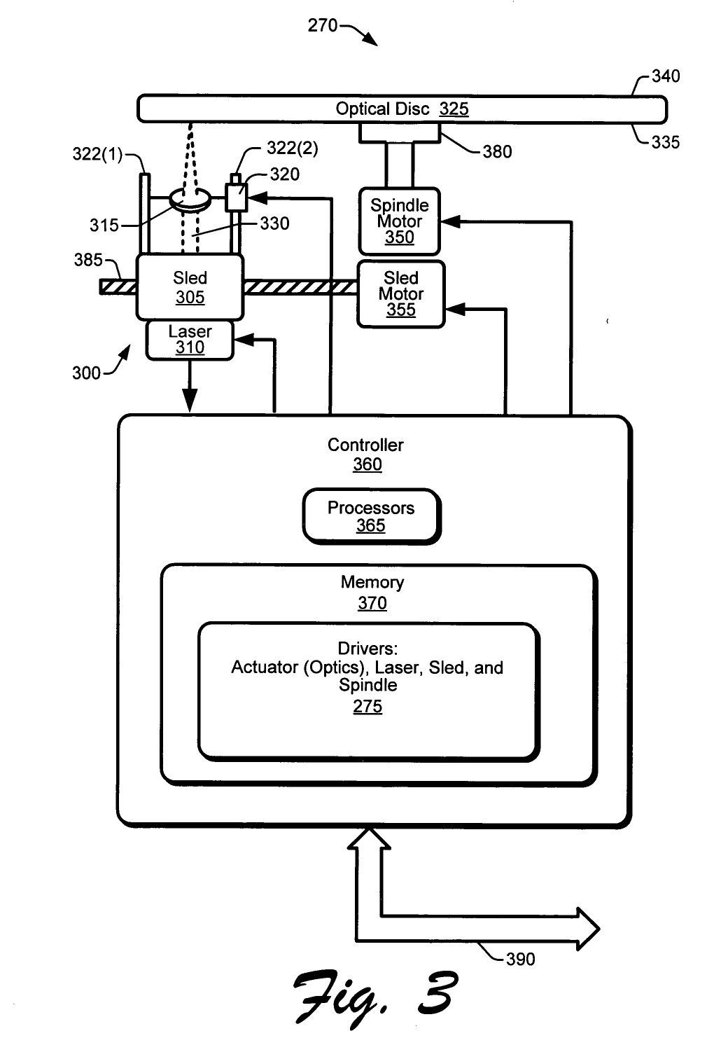

Digital video recorder 120 includes an optical disc drive (ODD) system 270 which may be configured to mark on a surface of an optical disc such as to render a label image on a label surface (i.e., label side) of an optical disc. The ODD system 270 is described in greater detail herein below with reference to FIG. 3.

Digital video recorder 120 further includes one or more communication interfaces 275, such as interfaces 155, 170 and 185 of FIG. 1, which may be implemented as any one or more of a serial and/or parallel interface, as a wireless interface, a network interface, and as any other type of communication interface. A wireless interface enables digital video recorder 120 to receive control input commands and other information from an input device, such as from a remote control device or from another infrared (IR), 802.11, Bluetooth, or similar RF input device. A network interface provides a connection between digital video recorder 120 and a data communication network which allows other electronic and computing devices coupled to a common data communication network such as network 105 of FIG. 1 to send label data and other information to digital video recorder 120 via the network. Content streams may also be received in this manner. Similarly, a serial and/or parallel interface provides a data communication path directly between digital video recorder 120 and another electronic or computing device.

Digital video recorder 120 may include user input devices 280 which may include a keyboard, pointing device, selectable controls on a user control panel, and/or other mechanisms to interact with, and to input information to digital video recorder 120. User input devices 280 may be used to select and enter text and graphics for an optical disc label.

In particular instances when information such as an EPG is interleaved or combined with a content stream such as a video stream it may be desirable to separate the information (EPG) from the video stream so that the information can be used as label data. A demodulator 285 is provided that separates such information from the content stream. In one embodiment, integrated circuit model OR51122 from the Oren Semiconductor Corporation may be included in demodulator 285.

Digital video recorder 120 further includes an audio/video processor 290 which generates content that is shown on display 115, and generates audio content for presentation by a presentation device, such as one or more speakers (not shown). The audio/video processor 290 may include a display controller which processes display content to display corresponding images on display 115. A display controller may be implemented as a graphics processor, microcontroller, integrated circuit, and/or similar video processing component to process the images. Video signals and audio signals may be communicated from digital video recorder 120 to display 115 via an RF (radio frequency) link, S-video link, composite video link, component video link, or other similar communication link.

Although shown separately, some of the components of digital video recorder 120 may be implemented in an application specific integrated circuit (ASIC). Additionally, a system bus (not shown) typically connects the various components within digital video recorder 120. A system bus may be implemented as one or more of any of several types of bus structures, including a memory bus or memory controller, a peripheral bus, an accelerated graphics port, or a local bus using any of a variety of bus architectures. Furthermore, digital video recorder 120 may share a system bus with a host processor.

FIG. 3 shows one embodiment of the ODD system 270 shown in FIG. 2. The ODD system 270 comprises an optical pickup unit (OPU) assembly 300 that includes a sled 305, a laser 310, optics 315, and an actuator 320. The actuator 320 responds to an input voltage (or current) to cause the optics 315 to move a focal point.

For purposes of illustration, the optics 315 are carried by lens supports 322(1), 322(2). The optics 315 are configured for travel (i.e. adjustment of the focal point) perpendicular to an optical disc 325 which may be a DVD.

A laser beam 330 is generated by the laser 310 and directed onto (reflected on) a label side surface 335 of optical disc 325. The laser beam 330 creates laser marks that correspond to label image data to render an image (i.e., text and graphics) to label side surface 335 of the optical disc 325. Laser beam 330 may also be directed onto a data side surface 340 of the optical disc 325 in order to record and play back broadcast content (data). In certain embodiments label side surface 335 and data side surface 340 are the same. In such embodiments, labels are rendered on, and data is recorded/played back from, the same side of optical disc 325.

In an embodiment, the label surface 325 is made up of a material that is responsive to laser marks by laser beam 330 generated by laser 310. As the laser marks are directed to the label surface 325 the label surface is “marked” with a particular corresponding portion (e.g. pixel) of an image such as represented by a label file described above.

The ODD system 270 includes a spindle motor 350, a sled motor 355, and a controller 360. In general, controller 360 may be implemented as a printed circuit board employing a combination of various components discussed above with respect to the digital video recorder 120 shown in FIG. 2. Accordingly, controller 360 includes a processor(s) 365 for processing computer/processor-executable instructions from various components stored in a memory 370. Processor(s) 365 is typically one or more of the processors 200 discussed above with respect to the digital video recorder 120 of FIG. 2. Likewise, memory 365 is typically the non-volatile memory 215 and/or firmware 225 of digital video recorder 120 of FIG. 2.

Drivers 375, including a laser driver, actuator driver, sled driver, and spindle driver are stored in memory 370 and executable on processor(s) 365. Although these components are represented in the FIG. 3 embodiment as software components stored in memory 370 and executable on processor 365, they may also be implemented as firmware or hardware components.

In general, a spindle driver drives the spindle motor 350 to control a rotational speed of optical disc 325 via a spindle 380. The spindle driver operates in conjunction with a sled driver which drives the sled motor 355 to control coarse radial positioning of OPU assembly 300 with respect to optical disc 325 along a sled drive mechanism 385.

In a focus position measurement operation, the sled 305 of the OPU assembly 300 is moved along the sled drive mechanism 385 to various radii positions of optical disc 325. Focusing may be performed using an optical sensor that determines when a focus position exists.

In a label surface marking operation, the rotational speed of optical disc 325 and the radial position of OPU assembly 300 are controlled such that laser marks are written at the proper locations on the optical disc 325 as the label side surface 335 moves past the laser beam 330.

A laser driver controls the firing of laser beam 330 to write laser marks corresponding to a label image onto the label side surface 335 at the proper locations. Additionally, the laser driver controls the intensity of the laser beam 330 to read or record data maintained on the data side 340 of the optical disc 325 when it is positioned such that the data side 335 passes over the laser beam 330. As described above, in certain cases, the same side is used for data and labeling.

A driver for actuator 320 is included among the drivers 375. The actuator driver is executable on processor 365 to adjust an actuator 320. Actuator driver further accounts for any inherent focus offset values to compensate for different rates of sweeping of OPU assembly 300 as performed by actuator 320. In other words, various sweeping rates of the OPU assembly 300 may produce different positions although the same “in focus” voltage is applied resulting in a focus offset value.

A computing device interface 390 interfaces the controller 335 of the ODD system 255 with another electronic or computing device such as DVR 120 to receive label image data or a label file (not shown). The computing device interface 390 can be implemented as an ATAPI (Advanced Technology Attachment Packet Interface), which is one of many small computer parallel or serial device interfaces. Another common computer interface is SCSI (small computer system interface), which is a generalized device interface for attaching peripheral devices to computers. SCSI defines the structure of commands, the way commands are executed, and the way status is processed. Various other physical interfaces include the Parallel Interface, Fiber Channel, IEEE 1394, USB (Universal Serial Bus), and ATA/ATAPI. ATAPI is a command execution protocol for use on an ATA interface so that CD-ROM and tape drives can be connected to the same ATA interface, and via the same ATA cable, as an ATA hard disc drive. ATAPI devices generally include CD-ROM drives, CD-recordable drives, CD-rewritable drives, DVD drives, tape drives, super-floppy drives (e.g., ZIP and LS-120), and the like.

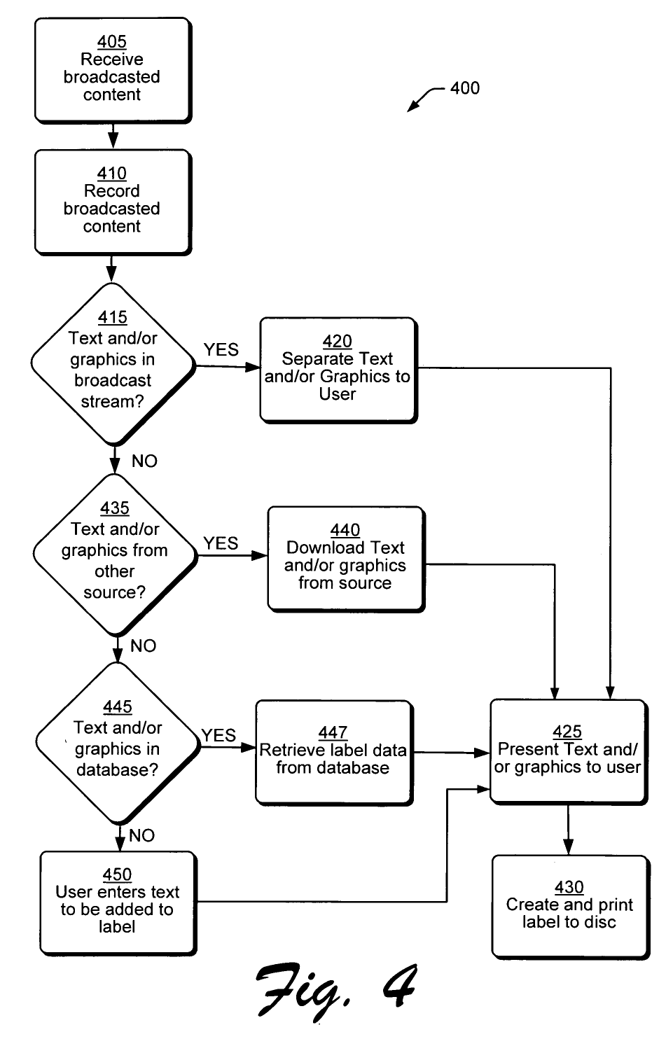

FIG. 4 shows one embodiment of a procedure 400 for adding text and/or graphics to an optical disc label. Procedure 400 allows a user to receive and record broadcast content from a source to an optical disc such as writeable DVD, and to create and print a label on the optical disc. The same device, such as the digital video recorder 120 described in FIG. 2, both records the content and prints the label onto the optical disc. In some embodiments, procedure 400 may be implemented in components described in FIG. 2 as described below, where such components include mechanisms or functions for performing the steps or blocks of procedure 400.

In particular instances, a user may override blocks of procedure 400 and proceed to a particular block or blocks in creating an printing a label to an optical disc.

At block 405, a digital video recorder system, and in particular a digital video recorder device such as digital video recorder system 110 and digital video recorder 120 described above, receives broadcasted content. The broadcasted content may be received from one or more sources such as broadcaster 125 of FIG. 1. The broadcasted content may be received through one or more interfaces as described above (i.e., satellite, RF antenna, cable network, etc.). Furthermore the broadcasted content may be received as a particular stream or streams of content that include interleaved video streams with EPG content.

At block 410, the digital video recorder system (device) records the broadcasted content to a recordable medium such as an optical disc using one of various recording formats, such as, for example DVD+RW, DVD-VR, and DVD-SR. Recording is performed on a data side of the optical disc as described above in FIG. 3, where the data side may or may not be the same side as a label side of the optical disc.

At block 415, a determination is made if optical disc label text and/or graphics or label data is part of the received broadcasted content. For example, a video stream may contain or be interleaved with an EPG containing label data that may be used for optical disc label text and/or graphics.

If the broadcasted content includes the label data (i.e., following the “YES” branch of block 415), block 420 is performed. The label data is separated from received broadcasted content such as a video stream. A demodulator such as demodulator 285 of FIG. 2 may be used to perform the separating of the label data from the received broadcasted content (i.e., video stream).

At block 425, label data is presented to the user. This may be done through a user interface such as user interface 250 of FIG. 2 where an optical disc label is shown as a preview image represented by graphics or image 260 and text 265 of FIG. 2. The user selects the preview image to be printed on the optical disc.

At block 430, a label is physically created and printed on an optical disc with the label data. Block 430 may be performed using the ODD system 270 described in FIG. 3. Included in block 430 may be a physical removal and inversion of the optical disc after recording (i.e., block 410) so that a label side of the optical disc may be written to by the ODD system 270.

If the broadcasted content does not include the label data (i.e, following the “NO” branch of block 415), or if the user desires to download label data from another source, a determination at block 435 made whether label may be received from another source. Such a source may a website such as website 140 of FIG. 1.

If a source is available to download label data (i.e., following the “YES” branch of block 435), block 440 is performed. A source such as website 140 of FIG. 1 is accessed as to label data applicable to the broadcasted content and the label data is downloaded to the digital video recorder system (device) to be printed as a label on the optical disc. Block 425 presents the text and/or graphics to be printed as a label to the user, and block 430 creates and prints the label to the optical disc.

If label data is not available from a source, (i.e, following the “NO” branch of block 435) or if the user desires to download label from a database, a determination at block 445 is made whether optical disc text and/or graphics is available from a resident database. The resident database may be database 212 of FIG. 2. If the resident database is available (i.e. following the “YES” branch of block 445), then at block 447 label data is retrieved from database 212. Block 425 presents the label data to be printed to the user, and block 430 creates and prints the label to the optical disc.

If label data is not available from a database, (i.e, following the “NO” branch of block 445) or if the user desires to enter text, block 450 is performed. The user may perform block 450 through a user input device such as user input devices 280 of FIG. 2. Block 425 presents the text entered by the user to be printed as a label, and block 430 creates and prints the label to the optical disc.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A digital video recorder comprising:
an interface to receive broadcast content;
a user input device to specify label data related to the broadcast content; and
an optical disc drive to record the broadcast content onto an optical disc and electro-optically label the specified label data onto the optical disc.

2. The digital video recorder of claim 1 wherein the interface further receives the label data.

3. The digital video recorder of claim 2 wherein the broadcast content and label data are received from different sources.

4. The digital video recorder of claim 3 wherein the broadcast content is received from one of a network, RF link, or streamed web site.

5. The digital video recorder of claim 3 wherein the label data is received from one of a database, web site, or broadcaster.

6. The digital video recorder of claim 1 wherein the user input device is used to enter text for the label data.

7. The digital video recorder of claim 1 wherein the broadcast content includes the label data and the digital video recorder further comprises a demodulator to separate the label data from the broadcast content.

8. The digital video recorder of claim 1 further comprising a database from which the label data is selected.

9. A method comprising:
receiving broadcasted content from a source;
electro-optically recording the broadcasted content onto an optical disc;
selecting label data related to the broadcasted content; and
electro-optically labeling the label data onto the optical disc.

10. The method of claim 9 wherein the receiving comprises receiving audio and video content streams from a broadcaster.

11. The method of claim 9 wherein the receiving comprises receiving radio frequency transmissions from a broadcaster.

12. The method of claim 9 wherein the selecting is performed by accessing a second source to download the label data.

13. The method of claim 9 wherein the selecting comprises presenting a preview label image to a user prior to the labeling.

14. The method of claim 9 wherein the selecting comprises entering text for the label data.

15. The method of claim 9 wherein the recording and the labeling are performed by an optical disc drive.

16. The method of claim 9 wherein the broadcasted content includes the label data and further comprising separating the label data from content data prior to the selecting.

17. The method of claim 9 wherein the label data comprises text and graphics.

18. A processor-readable medium comprising processor-executable instructions for electro-optically recording and labeling an optical disc, the processor-executable instructions comprising instructions for:
receiving audio and video content from a broadcaster,
recording the audio and video content to a content side of the optical disc using an optical disk drive;
receiving label data to be labeled on the label of the optical disc;
selecting the label data; and
labeling the selected label data to a label side of the optical disc using the optical disc drive.

19. The processor-readable medium of claim 18 wherein the receiving audio and video content is from a first source and receiving label data is from a second source.

20. The processor-readable medium of claim 19 wherein the second source is a website.

21. The processor-readable medium of claim 18 wherein the label data is part of the video content and wherein the instructions further comprise instructions for separating the label data from the video content.

22. The processor-readable medium of claim 21 wherein the label data is part of an electronic program guide.

23. A digital video recorder comprising:
means for receiving broadcasted content that includes streams of content;
means for recorded the broadcasted content to an optical disc;
means for determining if the broadcasted content includes label data; and
means for labeling the label to the optical disc.

24. The digital video recorder of claim 23 further comprising means for downloading the label data from a source.

25. The digital video recorder of claim 24 further comprising means for separating the label data from the broadcasted content if the broadcasted content includes the label data.

26. The digital video recorder of claim 24 further comprising means for previewing a label for the optical disc,
